(19) United States
(12) Patent Application Publication
(10) Pub. No.: US 2013/0068826 A1
(43) Pub. Date: Mar. 21, 2013

(54) Die Bonder and Bonding Method

(71) Applicants: Hiroshi Maki, Kumagaya (JP); Masayuki Mochizuki, Kumagaya (JP); Yukio Tani, Kumagaya (JP); Takehito Mochizuki, Kumagaya (JP)

(72) Inventors: Hiroshi Maki, Kumagaya (JP); Masayuki Mochizuki, Kumagaya (JP); Yukio Tani, Kumagaya (JP); Takehito Mochizuki, Kumagaya (JP)

(73) Assignee: Hitachi High-Tech Instruments Co., Ltd., Kumagaya-shi (JP)

(21) Appl. No.: 13/415,920

(22) Filed: Mar. 9, 2012

(30) Foreign Application Priority Data
Sep. 15, 2011 (JP) 2011-202275

(51) Int. Cl. B23K 31/02; B23K 37/04

(52) U.S. Cl. 228/221; 228/49.5

(57) ABSTRACT

A die bonder includes a die supply stage, which is configured to hold a wafer; a first head having a first collet, which is configured to pick up a die from the wafer and to attach the die, provisionally, on a target to be conducted with mounting thereon, on the attach stage; a second head having a second collet, which is configured to conduct main compression of the die, which is provisionally attached on the attach stage, on the target to be conducted with mounting; and a controller apparatus, wherein the controller apparatus controls the first head to pick up a next die from the die supply stage, during when the second head conducts the main compression on the die onto the target to be conducted with mounting, thereby achieving the die bonder and the die bonding method being stable in quality.

### BACKGROUND OF THE INVENTION

The present invention relates to a die bonder and a bonding method, and in particular, to a die bonder and a bonding method for enabling to reduce the number of processes thereof.

In a part of processes for mounting a die (i.e., a semiconductor chip) on a member to be mounted thereon, such as, a circuit board or a lead frame or the like (hereinafter, being called “a printed substrate”, in the present specification), thereby assembling a package, there is a bonding process for picking up (i.e., absorbing) a die from a wafer so as to bond it on the substrate. In recent years appears a die bonder, being manufactured with provision of two (2) heads, each for picking up and pressing the die on the substrate, so as to reduce the number of processes.

As die boding in such case are already known the following methods (1) to (3):
(1) Each head picks up dies from the wafer, sequentially, and bonds it (i.e., the die boding) on a work, such as, the substrate, as it is, directly;
(2) One of the heads picks up a die from the wafer, and puts it on a pre-alignment table, once. The other one of the heads absorbs the die, which was put on the pre-alignment table, and bonds it (i.e., the die bonding) on the work (see the following Patent Document 1); and
(3) A die is picked up from the wafer, and is attached, provisionally, on the work on a first stage. The work, on which the die is attached provisionally, is moved to a second stage, and the die is bonded (i.e., the die bonding) (see the following Patent Document 2).

### PRIOR ART DOCUMENTS

### Patent Documents

Patent Document 1: Japanese Patent Laying-Open No. 2000-252303 (2000); and

Patent Document 2: Japanese Patent Laying-Open No. 2005-093838 (2005).

### BRIEF SUMMARY OF THE INVENTION

With such the method (1) mentioned above, however since it gives influences on the processing times of the picking up and the main compression (i.e., the die bonding), respectively, a productivity is lowered down. Also, because of using two (2) heads, the products, which are produced with using the both heads, differ from in the quality thereof; i.e., stability cannot be obtained.

Also, with the methods (2) and (3) mentioned above, since the die is transferred after being put on a separate stage, once, there is a possibility of lowering of a yield rate by handling. Further, due to an influence when transferring it to the separate stage, there is also a possibility of lowering the yield rate. And also, since the two (2) stages are necessary, therefore the apparatus becomes large and increases the number of processes.

A first object of the present invention, by taking the problems mentioned above into the consideration thereof, lies to provide a die bonder and a die bonding method for stabilizing the quality of the die bonding.

Also, a second object of the present invention is to reduce the size of the die bonder and manufacturing costs thereof. And also, a third object of the present invention is to provide a die bonding and a die bonding method for enabling to reduce the number of processes of the die bonding.

For accomplishing the object(s) mentioned above, according to the present invention, first of all, there is provided a die bonder, comprising: a die supply stage, which is configured to hold a wafer; a first head having a first collet, which is configured to pick up a die from said wafer and to attach said die, provisionally, on a target to be conducted with mounting thereon, on said attach stage; a second head having a second collet, which is configured to conduct main compression of said die, which is provisionally attached on said attach stage, on said target to be conducted with mounting; and a controller apparatus, wherein said controller apparatus controls said first head to pick up a next die from said die supply stage, during when said second head conducts the main compression on said die onto said target to be conducted with mounting.

Also, according to the present invention, in the die bonder, as is described in the above, it is preferable that said controller apparatus evacuates said second head, before said first head provisionally attach said die on said target to be conducted with mounting.

Further, according to the present invention, in the die bonder, as is described in the above, it is preferable that said controller apparatus controls a load when said first header conducts the provisional attachment to be smaller than a load when said second head conducts the main compression.

Also, according to the present invention, in the die bonder, as is described in the above, it is preferable that said controller apparatus controls a load place time when said first header conducts the provisional attachment to be shorter than a load place time when said second head conducts the main compression.

And, according to the present invention, in the die bonder, as is described in the above, it is preferable that said first collet has a first heater device, while said second collet has a second heater device, and said controller apparatus controls a setup temperature of said first heater device to be lower than a setup temperature of said second heater device.

Also, according to the present invention, in the die bonder, as is described in the above, it is preferable that said attach stage has a third heater device for heating said target to be conducted with mounting, on said attach stage, and said controller apparatus determines a setup temperature of said third heater device to be same to the temperature when said first head conducts the provisional attachment on the die and when said second head conducts the main compression on said die.

Also, for accomplishing the object(s) mentioned above, according to the present invention, there is further provided a die bonding method in a die bonder comprising a first head having a first collet, a second head having a second collet, and a controller apparatus, comprising the following steps: a first step for said first head to pick up a die from a die supply stage; a second step for said second head to evacuate from above a die bonding point of a target to be conducted with mounting thereon, on an attach stage, and to attach said die, which is picked up, at said die bonding point, provisionally; a third step for said second head to apply main compression on said die, which is provisionally attached, so as to conduct the main compression of said die on said target to be conducted with mounting; and a fourth step for said first head to pick up another die from said die supply stage, during when executing said third step.

And, according to the present invention, in the die bonding method, as is described in the above, it is preferable that said first step includes a step for transferring said target to be conducted with mounting from an upstream down to said attach stage.

Further, according to the present invention, in the die bonding method, as is described in the above, it is preferable that said third step further transfers said target to be conducted with mounting, on which the main compression is conducted, to a downstream, after conducting said main compression, and transfers a next target to be conducted with mounting from said upstream.

Also, according to the present invention, in the die bonding method, as is described in the above, it is preferable that those steps from said second step to said fourth step are repeated.

And also, according to the present invention, in the die bonding method, as is described in the above, it is preferable that heating temperatures of said attach stage in said second step and in said third step are equal to each other.

Also, further according to the present invention, in the die bonding method, as is described in the above, it is preferable that heating temperature of said first collet is lower than heating temperature of said second collet.

Also, further according to the present invention, in the die bonding method, as is described in the above, it is preferable that a load when said first head conducts said provisional attachment in said second step is smaller than a load when said second head conducts said main compression in said third step.

Also, further according to the present invention, in the die bonding method, as is described in the above, it is preferable that a load when a load place time when said first head conducts said provisional attachment in said second step is shorter than a load place time when said second head conducts said main compression in said third step.

According to the present invention mentioned above, it is possible to achieve the die bonder and the die bonding method being stable in the quality of bonding.

Also, according to the present invention, it is possible to achieve the die bonder enabling a small-sizing and reducing a manufacturing cost.

Further, according to the present invention, it is possible to achieve the die bonder and the die bonding method for enabling to reduce the number of steps.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is an outlook side view of a principle portion of a die bonder, according to an embodiment of the present invention;

FIG. 2 is an outlook side view of a head of the die bonder, according to the embodiment of the present invention;

FIG. 3 is a block diagram for showing the configuration of a controller apparatus, according to the embodiment of the present invention;

FIGS. 4A to 4C are outlook side views for showing the principle portion of the die bonder, for explaining the die bonder and a die bonding method, according to the embodiment of the present invention;

FIGS. 5A to 5C are outlook side views for showing the principle portion of the die bonder, for explaining the die bonder and a die bonding method, according to the embodiment of the present invention;

FIG. 6 is a block diagram for showing the configuration of a controller apparatus, according to the embodiment of the present invention; and

FIG. 7 is a block diagram for showing the configuration of a controller apparatus, according to the embodiment of the present invention.

### DETAILED DESCRIPTION OF THE PREFERRED EMBODIMENTS

Hereinafter, explanation will be given on an embodiment according to the present invention, by referring to the attached drawings, etc. However, in the explanation, which will be given below, is for explaining one embodiment according to the present invention, but not for limiting the scope of the present invention to that. Accordingly, for the person skilled in the art, it is possible to apply an embodiment, in which each or all of those elements is/are substituted with an equivalent(s) thereto, and those embodiments would be included in the scope of the present invention.

Further, in the present specification, the constituent element(s) having the common function(s) thereto will be attached with the same reference numeral(s), and duplication of the explanation thereof will be omitted, in each explanation of the drawings.

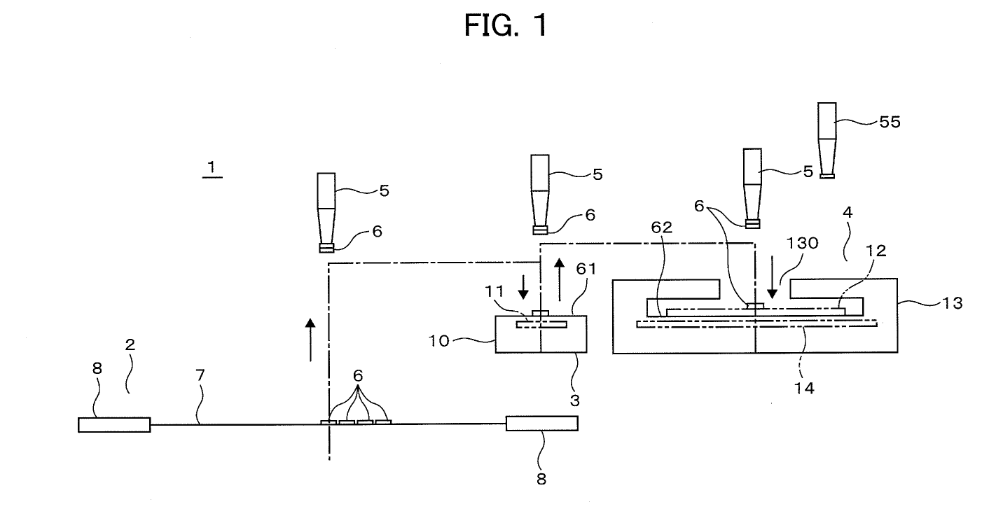

FIG. 1 is an outlook side view of a principle portion of a die bonder, according to an embodiment of the present invention. This die bonder is an apparatus for mounting various kinds of dies (i.e., the semiconductor chips) on a printed substrate. A reference numeral 1 depicts a main body of the die bonder, 2 a die supply stage, 3 a pre-alignment stage, 4 an attach stage for doing the die bonding job thereon, 6 a die, 5 a collet for absorbing the die 6, so as to attach it on the printed substrate, provisionally, 55 a collet for conducting the die bonding (i.e., the main compression) of the die 6, which is attached, provisionally, 7 a semiconductor wafer, 8 a wafer table for mounting and supporting the semiconductor wafer 7 thereon, 10 a pre-alignment table of the pre-alignment stage 3, 11 a heater device for heating the pre-alignment table 10, 12 a printed substrate, being a member to be mounted with the die 6 thereon, 13 an attach table of the attach stage 4, 61 an upper surface of the pre-alignment table 10, 62 an upper surface of the attach table 13, 130 is an opening portion of the attach table 13, and 14 a heater device for heating the attach table 13, respectively. Further, the collet 5 is provided on a head 20, which will be mentioned later, while the collect 55 is provided on the head 20′, which will be mentioned later.

In FIG. 1, on the die supply stage 2 is mounted, for example, the semiconductor wafer (hereinafter, being called “a wafer”) 7 aggregating a large number of the dies 6. The wafer 7 is already treated a dicing thereon, so that each of the dies 6 can be picked up, separately.

The pre-alignment stage 3 has the pre-alignment table 10, and the heater device 11, which is provided below this pre-alignment table 10. Also, the attach stage 4 has the attach table 13, for mounting the printed substrate 12 thereon and covering the periphery of the printed substrate 12, and also being formed the opening portion 130 on the upper surface thereof, and the heater device 14, being provided on this attach table 13. The printed substrate 12 is transferred by means of a transfer mechanism not shown in the figure, on the attach table 13, from an upstream, and after completion of the mounting job (i.e., the die bonding) of the die 6, it is transferred to a downstream.

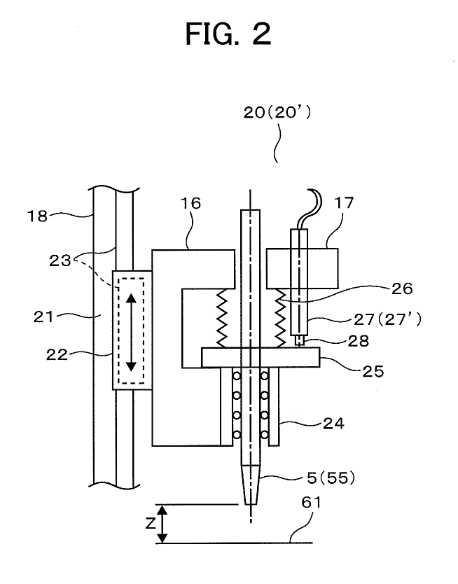

Hereinafter, explanation will be given on the head 20 for moving and mounting and then provisionally attaching the die 6, and the head 20′ for conducting the main compression, by referring to FIG. 2. FIG. 2 is an outlook side view of a head of the die bonder, according to the embodiment of the present invention. The head 20 for moving and mounting the die 6 from the die supply stage 2 to the pre-alignment stage 3 and provisionally attaching the die 6 and the head 20′ for conducting the main compression, on which is provisionally attached the die 6, are same mechanisms, and therefore, hereinafter, explanation will be given on the head 20, which moves the die 6 from the die supply stage 2 through the pre-alignment stage 3 to the attach stage 4, so as to mount it thereon, and thereby attaching the die on the printed substrate 12, provisionally, while the explanation will be omitted herein, about the head 20′ for conducting the main compression of the die 6 on the attach stage 4. However, the reference numerals within parenthesis show that they are the constituent elements relating to the head 20′.

A reference numeral 16 depicts a head support portion of the head 20 (20′), 17 a sensor support portion extending outside from an upper portion thereof with respect to the head support portion 16, 18 a guide, 21 a rail, 22 a slide member, 23 (23′) an elevating drive portion (a stator and a (movable) needle), 24 a ball bush, 25 a contact block, 26 a compression spring, 27 (27′) a touch sensor, and 28 a contact end, respectively.

The head support portion 16 goes up and down along the guide 18, which is arranged in the vertical (up and down) direction.

The guide 18 has the rail 21, and the slide member 22, which is supported on the rail 21, to be able to slide freely thereon. Also, on the guide 18 is provided the elevating drive portion 23 for the head 20, such as, a linear motor, etc., for example.

Also, in a lower portion of the head support portion 16 is provided a ball bush 24, in a direction nearly perpendicular thereto, and on this ball bush 24 is supported the collet 5 (55) to elevate freely in nearly the vertical direction thereto. Also, around at an intermediate position of the collet 5 is attached the contact block 25 in the horizontal direction. Between an upper surface of this contact block 25 and a lower surface of the sensor support portion 17 is provided the compression spring 26, and by means of the compression spring 26 is biased the collet 5 downwards, through the contact block 25. The touch sensor 27 (27′) is a sensor, being attached penetrating through the sensor support portion 17. At a lower end of the touch sensor 27 is provided the contact end 28. And, under the condition that the collet 5 does not go up while contacting the lower end thereof on another member, a very small gap is defined between the lower end of the contact end 28 and the upper surface of the contact block 25.

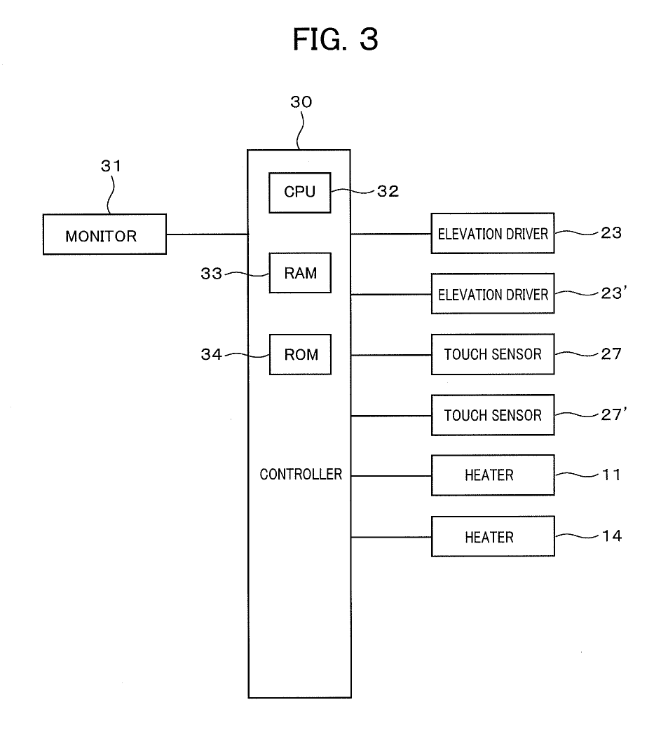

Next, explanation will be made on a controller apparatus for controlling the operation of the head 20 (20′), such as, elevations, etc., upon basis of FIG. 3. FIG. 3 is a block diagram for showing the configuration of the controller apparatus for the die bonder, according to the embodiment of the present invention.

A reference numeral 30 depicts the controller apparatus for controlling the operation, such as, elevations of the elevation driver portion 23, etc., 31 a monitor, 32 a CPU (Central Processing Unit), 33 a RAM (Random Access Memory), and 34 a ROM (Read Only Memory), respectively.

To this controller apparatus 30 are connected through an interface (not shown in the figure) the elevation driver portions 23 and 23′, the touch sensors 27 and 27′, the monitor 31 having a touch panel as a display device, etc.

Within the controller apparatus 30 are provided the CPU 32, the RAM 33 and the ROM 34, wherein the CPU 32, inputting signals from the touch sensors 27 and 27′, controls the elevation driver portion 23 upon basis of data of elevation stroke, which is stored in the ROM 33 in advance, and control program, which is stored in the ROM 34, and also controls the heater device 11 of the pre-alignment table 10 and the heater device 14 of the attach table 13 upon basis of the values detected by a thermo sensor or the like, but not shown in the figure; i.e., controlling the temperature of the pre-alignment table 10 and the attach table 13.

Also, in the RAM 33 are stored a distance (or, a time period) and the number of times for correction (calibration) of a down stroke of the collet 5 or 55, i.e., the distance (or, the time period) and the number of times for collecting the down stroke, which are set up through operations by a worker in advance.

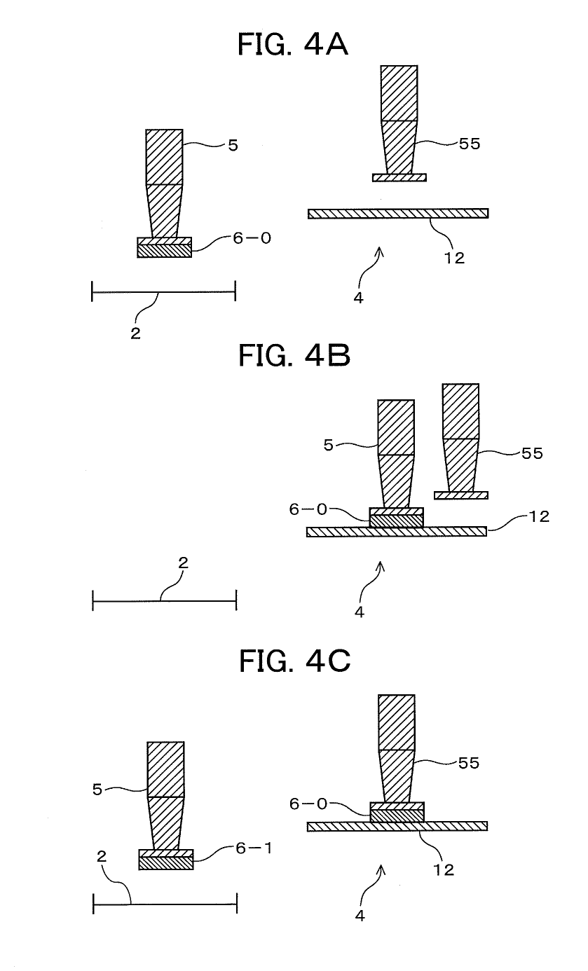

By referring to FIGS. 4A to 4C, explanation will be made on the die bonder and the die bonding method, according to the embodiment of the present invention. FIGS. 4A to 4C are views for showing outlook side views of the principle portions of the die bonder, for explaining the die bonder and the die bonding method, according to the embodiment of the present invention. FIGS. 4A to 4C show constituent elements, but deleting ones, which are unnecessary for explaining, in the die bonder according to the embodiment of the present invention. Further, in the embodiment shown in FIGS. 4A to 4C, differing from the embodiment shown in FIG. 1, the collet 5 of the head 20 provisionally attaches the die 6, which is picked up from the die supply area or stage 2, on the printed substrate 12 on the attach stage 4, directly. For this reason, there is provided no pre-alignment stage 3. Also, suffixes are attached to the die 6 shown in FIGS. 4A to 4C, for distinguishing it is the same die or not, for example, the die 6-0 and the die 6-1.

In FIG. 4A shows the condition that the die boding is started on one kind of the substrate. Thus, the printed substrate 12 is transferred from an upstream onto the attach stage 4 by means of a transfer mechanism not shown in the figure, and at this time, the collet 55 of the collet 20′ is positioned above the printed substrate 12. During the time when the printed substrate 12 is transferred onto the attach stage 4, the collet 5 of the head 20 moves onto the die supply stage 2, so as to pick up the die 6-0.

Next, as is shown in FIG. 4B, the collet 55 is evacuated from, above a die bonding point on the printed substrate 12. And, above the die bonding point is moved the collet 5, which picks up the die 6-1, so as to provisionally attach the die 6-0 at the die bonding point on the printed substrate 12. The distance to evaluate is so determined that the head 20′ of the collet 55 does not contact on the head 20 of the collet 5.

Next, as is shown in FIG. 4C, the collet 5 completing the provisional attachment of the die 6-0 moves onto the die supply stage 2, and picks up other die 6-1. During the time when the collet 5 of the head 20 picks up the other die 6-1, the collet 55 of the head 20′ conducts the die bonding (e.g., the main compression) by suppressing the die 6-0, which is provisionally attached before, on the same stage from the above. After completing the die bonding (e.g., the main compression), the collet 5 of the head 20′ moves above the attach stage 4, and the printed substrate 12, on which the die 6-0 is mounted, is transferred to a downstream by means of the transfer mechanism not shown in the figure, and also a next printed substrate is transferred from the upstream down onto the attach stage 4.

Hereinafter, the steps of the processes shown in FIGS. 4B and 4C are repeated, alternately, so that the die 6 is mounted on the printed substrate 12.

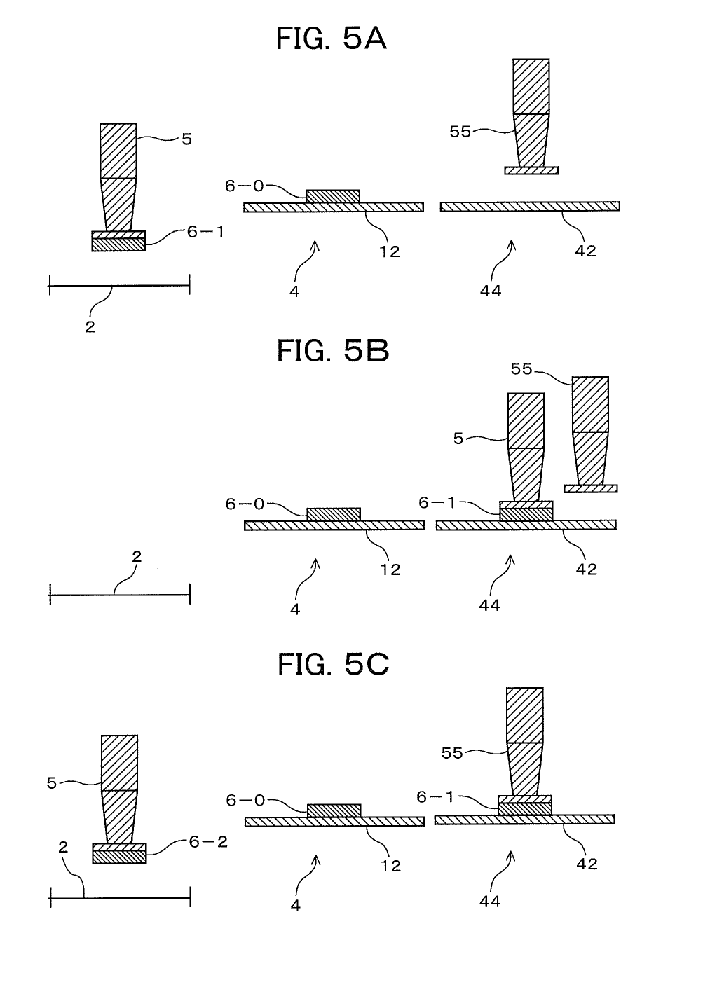

Explanation will be made on the die bonder and the die bonding method, according to other embodiment of the present invention, by referring to FIGS. 5A to 5C. FIGS. 5A to 5C are views for showing outlook side views of the principle portions of the die bonder, for explaining the die bonder and the die bonding method, according to the embodiment of the present invention. FIGS. 5A to 5C show constituent elements, but deleting ones, which are unnecessary for explaining, in the die bonder according to the embodiment of the present invention. Further, the embodiment shown in FIGS. 5A to 5C, differing from the embodiment shown in FIGS. 4A to 4C, comprises two (2) lanes of mounting lines, wherein the two (2) heads 20 and 20′ mount the dies, alternately, on the printed substrates, which are transferred on the two (2) lanes respectively. Herein, the reference numeral 12 depicts the printed substrate, which is transferred on a first lane, while 42 depicts the printed substrate, which is transferred on a second lane. Also, the reference numeral 4 depicts an attach stage for the first lane, while 44 depicts an attach stage for the second lane.

In FIGS. 5A to 5C, the die 6-0 is mounted on the printed substrate 12, in accordance with the steps of processes explained in FIGS. 4A to 4C. However, in FIG. 5C, the collet 55 after completing the die boding (e.g., the main compression) moves onto the attach stage 44. Next, as is shown in FIG. 5A, the printed substrate 42 is already transferred from the upstream on the attach stage 44 by means of the transfer mechanism not shown in the figure (or is transferred in advance, and is under waiting condition).

Next, as is shown in FIG. 5B, the collet 55 is evacuated from above the die bonding point on the printed substrate 42. And, above the die bonding point is moved the collet 5, which picks up the die 6-1, so as to provisionally attach the die 6-1 at the die bonding point on the printed substrate 42.

Next, as is shown in FIG. 5C, the collet 5 completing the provisional attachment of the die 6-1 moves onto the die supply stage 2, and picks up other die 6-1. During the time when the collet 5 of the head 20 picks up the other die 6-2, the collet 55 of the head 20′ conducts the die bonding (e.g., the main compression) by suppressing the die 6-1, which is provisionally attached before, on the same stage from the above. After completing the die bonding (e.g., the main compression), the collet 5 of the head 20′ moves above the attach stage 4, and the printed substrate 12, on which the die 6-1 is mounted, is transferred to a downstream by means of the transfer mechanism not shown in the figure, and also a next printed substrate is transferred from the upstream down onto the attach stage 44.

Hereinafter, the steps of the processes shown in FIGS. 4B and 4C and those shown in FIGS. 5B and 5C are repeated, alternately, so that the dies 6 are mounted on the printed substrates 12 and 42.

For example, a load (Light Place Load) of the head for the pre-attachment is 0.5 to 2 [N] (load placing time (Short Place Time):0.1 to 0.5 [s]), a load (Heavy Place Load) of the head for the die bonding (e.g., the main compression) is 1 to 70 [N] (load placing time (Heavy Place Time): 0.5 [s] or longer than that).

According to the present embodiment mentioned above, the picking up and the die bonding (e.g., the main compression) are conducted by separate heads, respectively. Thus, the same jobs are executed by the same heads, respectively. For this reason, the processes can be conducted in parallel, then the process time receives no ill influences, and the quality of the mounting is stabled, but and not be lowered in the productivity thereof.

Also, since the stage for use of the provisional attachment is not necessary, it is enough to provide only one (1) heating stage, and thereby enabling to reduce the size of the apparatus and the cost thereof, as well as, lowering the number of manufacturing steps.

Further, since it is also possible to reduce the number of times of handlings, it is possible to prevent the yield rate due to the handlings from being lowered.

For example, in case where the type of product is a thin-type laminated product, such as, NADA or the like, for example, there is necessity of a process time of about 1 [s], for each, in the die bonding by the picking up (exfoliation) and the thermal compression. According to the present invention, it is possible to conduct the respective processes (the picking up and the thermal compression) in parallel with.

According to the present invention, the two (2) collets 5 and 55 bear the rolls different from each other. However, in the embodiments shown in FIGS. 1 to 5C mentioned above, as the collet 5 to be used for the picking up and the provisional attachment and the collet 55 to be used for the die bonding (the main compression) are used the collets having the same configuration and the same sizes. Also, the setup conditions of the temperature, etc., for the pre-alignment stage 3, the attach stage 4, the collet 5 and the collet 55 are determined to be same to one another.

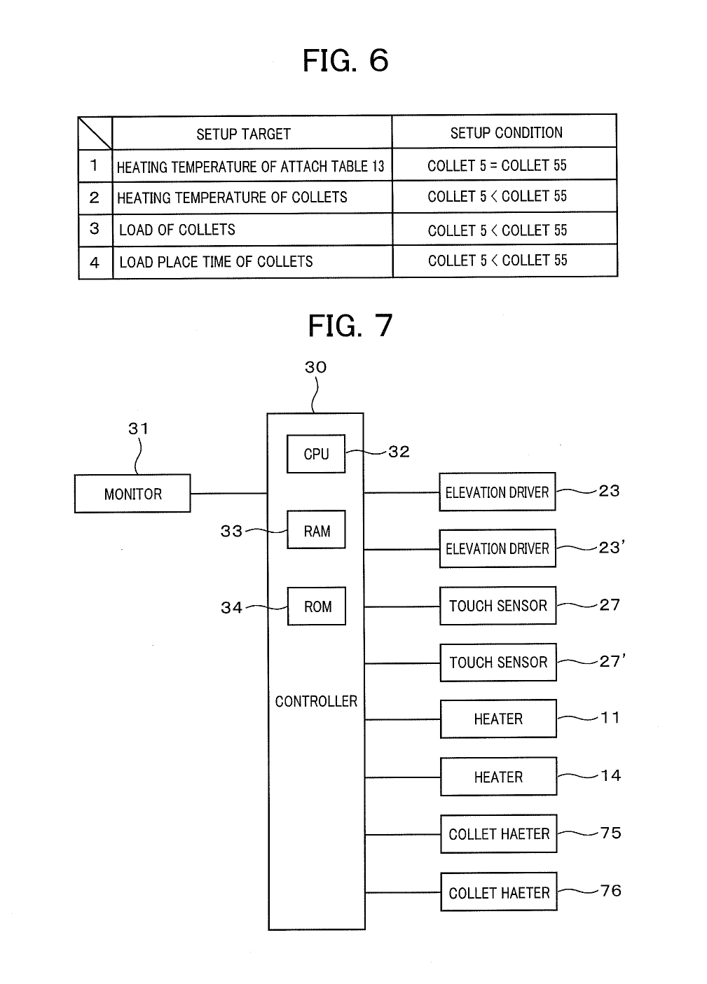

However, as other embodiment of the present invention, for example, as is shown in FIG. 6, the job conditions maybe different to each other, between the collet 5 for use of the provisional attachment and the collet 55 for use of the die bonding (i.e., the main compression).

FIG. 6 shows a table for showing a setup condition of the die bonder, according to one embodiment of the present invention. In FIG. 6, the setup condition is so determined that the setup conditions for the collet 5 for use of the provisional attachment and the collet 55 differ from each other, on targets to be determined.

In FIG. 6, the heating temperature of the attach table 13 is determined to be same, when the provisional attachment and the die bonding (e.g., the main compression) are conducted by the collet 5. However, any one of the heating temperature, the load of the collet and the load place time of the collet 5 for use of the provisional attachment is larger than that for use of the die bonding (e.g., the main compression).

As a result of this, since the die bonding can be done with the temperature lower than that when conducting the die bonding (e.g., the main compression), when conducting the provisional attachment, it is easy to maintain the accuracy of the bonding position due to the influence of temperature. Also, with the same reason, it is possible to protect the printed substrate from being thermally deformed. Further, since the heating is applied from the collet side, not passing through the printed substrate, it is possible to obtain heat conductivity (thermal conductivity) and to improve the quality of die bonding (compressing).

Since provision of heater devices 75 and 76, as is shown in FIG. 6, is within the conventional technology, the explanation thereof will be omitted herein. However, controlling of the heater devices 75 and 76 of the collets 5 and 55 can be achieved by connecting the heater devices 75 and 76 with the controller apparatus 30, as is shown in FIG. 7, within the controller apparatus shown in FIG. 3.

However, further, the collet 5 for use of picking up and the provisional attachment and the collet 55 for use of the die bonding (e.g., the main compression) may be ones having the configuration and size differing from, fitting to the way of uses thereof. As a result of this, it is possible to improve the quality of the die bonding, further.

In the embodiment mentioned above, the explanation was given about the present invention, in particular, with using the die bonder attached with an intermediate stage (i.e., the pre-alignment table) and the die bonder of direct bonding method. However, the die bonder and the die bonding method, according to the present invention, can be applied, widely, into a flip-chin bonder, a heat compression die bonder and an ultrasonic and heating die bonder, etc., other than the die bonders mentioned above.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A die bonder, comprising:
a die supply stage, which is configured to hold a wafer;
a first head having a first collet, which is configured to pick up a die from said wafer and to attach said die, provisionally, on a target to be conducted with mounting thereon, on said attach stage;
a second head having a second collet, which is configured to conduct main compression of said die, which is provisionally attached on said attach stage, on said target to be conducted with mounting; and
a controller apparatus, wherein
said controller apparatus controls said first head to pick up a next die from said die supply stage, during when said second head conducts the main compression on said die onto said target to be conducted with mounting.

2. The die bonder, as is described in the claim 1 mentioned above, wherein said controller apparatus evacuates said second head, before said first head provisionally attach said die on said target to be conducted with mounting.

3. The die bonder, as is described in the claim 1 mentioned above, wherein said controller apparatus controls a load when said first header conducts the provisional attachment to be smaller than a load when said second head conducts the main compression.

4. The die bonder, as is described in the claim 1 mentioned above, wherein said controller apparatus controls a load place time when said first header conducts the provisional attachment to be shorter than a load place time when said second head conducts the main compression.

5. The die bonder, as is described in the claim 1 mentioned above, wherein said first collet has a first heater device, while said second collet has a second heater device, and said controller apparatus controls a setup temperature of said first heater device to be lower than a setup temperature of said second heater device.

6. The die bonder, as is described in the claim 1 mentioned above, wherein said attach stage has a third heater device for heating said target to be conducted with mounting, on said attach stage, and said controller apparatus determines a setup temperature of said third heater device to be same to the temperature when said first head conducts the provisional attachment on the die and when said second head conducts the main compression on said die.

7. A die bonding method in a die bonder comprising a first head having a first collet, a second head having a second collet, and a controller apparatus, comprising the following steps:
a first step for said first head to pick up a die from a die supply stage;
a second step for said second head to evacuate from above a die bonding point of a target to be conducted with mounting thereon, on an attach stage, and to attach said die, which is picked up, at said die bonding point, provisionally;
a third step for said second head to apply main compression on said die, which is provisionally attached, so as to conduct the main compression of said die on said target to be conducted with mounting; and
a fourth step for said first head to pick up another die from said die supply stage, during when executing said third step.

8. The die bonding method, as described in the claim 7, wherein said first step includes a step for transferring said target to be conducted with mounting from an upstream down to said attach stage.

9. The die bonding method, as described in the claim 7, wherein said third step further transfers said target to be conducted with mounting, on which the main compression is conducted, to a downstream, after conducting said main compression, and transfers a next target to be conducted with mounting from said upstream.

10. The die bonding method, as described in the claim 7, wherein those steps from said second step to said fourth step are repeated.

11. The die bonding method, as described in the claim 7, wherein heating temperatures of said attach stage in said second step and in said third step are equal to each other.

12. The die bonding method, as described in the claim 7, wherein heating temperature of said first collet is lower than heating temperature of said second collet.

13. The die bonding method, as described in the claim 7, wherein a load when said first head conducts said provisional attachment in said second step is smaller than a load when said second head conducts said main compression in said third step.

14. The die bonding method, as described in the claim 7, wherein a load when a load place time when said first head conducts said provisional attachment in said second step is shorter than a load place time when said second head conducts said main compression in said third step.
